(19) United States
(12) Patent Application Publication
(10) Pub. No.: US 2025/0172507 A1
(43) Pub. Date: May 29, 2025

(54) METHOD FOR QUENCH DETECTION USING RF INTERROGATION OF COOLANT PERMITTIVITY

(71) Applicant: Ohio State Innovation Foundation, Columbus, OH (US)

(72) Inventors: Chris KOVACS, Columbus, OH (US); Mike SUMPTION, Columbus, OH (US); Tom BULLARD, Columbus, OH (US)

(21) Appl. No.: 18/961,890

(22) Filed: Nov. 27, 2024

Related U.S. Application Data
(60) Provisional application No. 63/602,750, filed on Nov. 27, 2023.

(51) Int. Cl. G01N 22/00

(52) U.S. Cl. CPC G01N 22/00

(57) ABSTRACT

The present disclosure presents systems and methods for detecting a quench event in a superconductor. One such system comprises a cable extending down a metal tubular conduit and being cooled by a dielectric liquid near boiling point conditions to form a cable-conduit system; and a vector network analyzer that is configured to inject a stimulus signal and detect a local hot spot formation on the cable via a change in relative permittivity of the cable-conduit system.

### CROSS-REFERENCE TO RELATED APPLICATION

This application claims priority to co-pending U.S. provisional application entitled, “Method for Quench Detection Using RF Interrogation of Coolant Permittivity,” having application No. 63/602,750, filed Nov. 27, 2023, which is entirely incorporated herein by reference.

### STATEMENT REGARDING FEDERALLY SPONSORED RESEARCH OR DEVELOPMENT

This invention was made with government support under 80NSSCG23MO63 awarded by the National Aeronautics and Space Administration. The government has certain rights in the invention.

### BACKGROUND

Superconducting materials can be used in a variety of applications including, but not limited to, superconducting electrical transmission lines, superconducting electrical coils, superconducting magnets, superconducting electronics, cables, and tapes. Such superconducting materials are capable of superconducting electrical current under suitable operation conditions. As superconducting materials technology improves, the useful applications for such materials increase.

Some superconducting materials require operation at lower temperatures, relative to other superconducting materials. Local hot spots can develop within the superconductor while operating in its superconducting state and can cause the superconducting devise to quench (rapidly transition into its normal conducting state) resulting in potential damage to the superconducting material cable or other components of the system in which the superconducting material is employed, if not detected in time.

Current state of the art techniques for detecting a quench event or hot spot formation have used regularly spaced voltage taps (resistivity increases with temperature), temperature sensitive dies and visual recording, magnetic sensors (to detect changes in current distribution), audio frequency ultrasonic transducers (detect vibrations from vibrational stresses introduced from hot spot formation), added waveguides (such as optical fiber gratings) which detect temperature by varying means, and a recent technique has used the superconducting composite conductor itself as a waveguide (in the case of a yttrium barium copper oxide (YBCO) coated conductor, this is possible due to the dielectric buffer layer surrounded by conductive and superconductive elements).

The voltage tap method suffers from the need to regularly space voltage taps to detect local hotspots, and for long superconducting cables this can be difficult due to the need of an extreme number of voltage taps and data acquisition. The requirement of integrated optical analysis for temperature sensitive dies can lead to difficulties for a long cable. In addition, the selection of temperature sensitive dies that function at cryogenic temperatures less than 77 K is lacking and their excitation and relaxation require special optical systems. Magnetic detection systems are exceedingly complex to analyze due to the nature of interconductor contact resistivity. In addition, the magnetic detection systems are similar to voltage taps in that a regular spacing is required and the instrumentation will interfere with cooling and fluid flow conditions. The integration of optical waveguides is difficult because any separation from the hot spot will only measure the temperature of the surrounding fluid (two-phase temperature=boiling temperature of). In addition, the added instrumentation reduces the available area for cooling for the electrical superconducting cable, constricts fluid flow, and requires advanced and rugged optical feedthroughs. Using a linear non-periodic waveguide (such as the YBCO superconducting tape) has been demonstrated to properly function in detecting large hot spots in short lengths of tape. However, RF coupling to the individual tapes may provide some difficulties at the cable terminations, and the longitudinal non-periodic nature of the YBCO tape waveguide will reduce the characteristic frequency for different lengths and possibly reduce hot spot detection capability for long lengths.

Therefore, it would be beneficial if there were a system and method that could readily identify quench conditions without the drawbacks of the current technologies.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram of a system for detecting a quench event in a superconducting material in accordance with various embodiments of the present disclosure.

FIG. 2 is diagram of a cryostat-cable structure in accordance with various embodiments of the present disclosure.

FIG. 3 shows an example cable in corrugated cable conduit in accordance with various embodiments of the present disclosure.

FIG. 4 shows RF-signal quench detection using RF interrogation of coolant permittivity in accordance with various embodiments of the present disclosure.

FIG. 5 is a block diagram of a computing device that may be used in a computing system of FIG. 1.

### DETAILED DESCRIPTION

Described herein are techniques for detecting a quench event in a superconductor. These techniques include detecting a change in relative permittivity of a superconducting dielectric gas-liquid system. This can involve a superconducting cable traveling down an inner layer of a cable crystotat and being cooled by a dielectric liquid. When a quench event occurs, the superconductor material generates heat that vaporizes the dielectric liquid coolant. Accordingly, in this type of system, local hot spot formation on the superconducting cable will create vaporization conditions and rapidly change the relative permittivity of the now gas-liquid dielectric system. Thus, detection of localized heating via changes in radio frequency (RF) impedance in the dielectric liquid can be performed using an RF signal detector (e.g., vector network analyzer or other type of measurement device) for measuring impedance parameters.

Superconductors are materials that have no electrical resistance to current below a critical temperature. To remain in a superconducting state, the superconducting material must remain at a temperature below the critical temperature. However, localized energy dissipation (e.g., due to current flow in the superconductor) can cause localized heating, which, if not controlled or detected, may result in a thermal runaway event that causes the entire superconductor to transition from the superconducting regime to a normal, resistive regime. A quench event not only can result in downtime of the superconducting device but may result in damage to the superconducting device as well.

To reduce the risk of a quench, quench detection and protection systems are used to detect a quench event and to prevent or mitigate damage by removing all of the current and stored energy from the superconductor. Conventional quench detection systems typically have used regularly spaced voltage taps (resistivity increases with temperature), temperature sensitive dies and visual recording, magnetic sensors (to detect changes in current distribution), audio frequency ultrasonic transducers (detect vibrations from vibrational stresses introduced from hot spot formation), added waveguides (such as optical fiber gratings) which detect temperature by varying means, and a recent technique has used the superconducting composite conductor itself as a waveguide (in the case of yttrium barium copper oxide (YBCO) coated conductor this is possible due to the dielectric buffer layer surrounded by conductive and superconductive elements).

The voltage tap method suffers from the need to regularly space voltage taps to detect local hotspots, and for long superconducting cables this can be difficult due to the need of an extreme number of voltage taps and data acquisition. For a long cable, any additional instrumentation will interfere with the cooling conditions and constrict fluid flow. Even with the most sensitive and advanced rapid triggering techniques, the voltage tap method is currently incompatible with many high temperature superconductors composites (HTS), which can develop hard to detect (very small and slow growing) hot spots. Due to the long detection time, and short time required for burnout, there is a consensus to try to move away from the voltage tap method for rapid detection.

Temperature sensitive dies sound straight forward, but the requirement of integrated optical analysis can lead to difficulties for a long cable. In addition, the selection of temperature sensitive dies that function at cryogenic temperatures less than 77 K is lacking and their excitation and relaxation requires special optical systems.

Magnetic detection systems do indeed function in detecting changes in current distribution from hot spot formation, but in a cable these signals are exceedingly complex to analyze due to the nature of interconductor contact resistivity. In addition, the magnetic detection systems are similar to voltage taps in that a regular spacing is required and the instrumentation will interfere with cooling and fluid flow conditions.

Optical waveguides, such as highly integrated fiber optic gratings, do function pretty well as a hot spot detection system. However, the integration of optical waveguides is difficult because any separation from the hot spot will only measure the temperature of the surrounding fluid (two-phase temperature=boiling temperature). In addition, the added instrumentation reduces the available area for cooling for the electrical cable, constricts fluid flow, and requires advanced and rugged optical feedthroughs.

Using a linear non-periodic waveguide (such as the YBCO superconducting tape) has been demonstrated to properly function in detecting large hot spots in short lengths of tape. However, RF coupling to the individual tapes may provide some difficulties at the cable terminations, and the longitudinal non-periodic nature of the YBCO tape waveguide will reduce the characteristic frequency for different lengths and possibly reduce hot spot detection capability for long lengths.

In accordance with the present disclosure, the inventors have developed an RF-signal quench detection system for detecting a quench event in a superconducting material. In some embodiments, the superconducting material is a cable extending down a corrugated metal tubular conduit and being cooled by a dielectric liquid near boiling point conditions to form a cable-conduit system, where the system involves an RF signal detector (e.g., vector network analyzer) being configured to inject a stimulus signal and detect a local hot spot formation on the cable via a change in relative permittivity of the cable-conduit system.

Following below are more detailed descriptions of various concepts related to, and embodiments of, techniques for RF-signal quench detection. It should be appreciated that various aspects described herein may be implemented in any of numerous ways. Examples of specific implementations are provided herein for illustrative purposes only. In addition, the various aspects described in the embodiments below may be used alone or in any combination and are not limited to the combinations explicitly described herein.

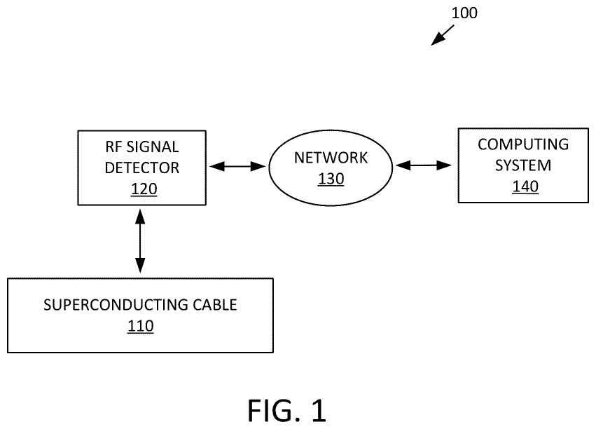

FIG. 1 is a schematic diagram of a system 100 for detecting a quench event in a superconducting material, in accordance with some embodiments described herein. In the illustrative example of FIG. 1, the system 100 includes a superconducting cable 110, an RF signal detector 120, a network 130, and a computing system 140. It should be appreciated that system 100 is illustrative and that an RF-signal quench detection system may have one or more other components of any suitable type in addition to or instead of the components illustrated in FIG. 1.

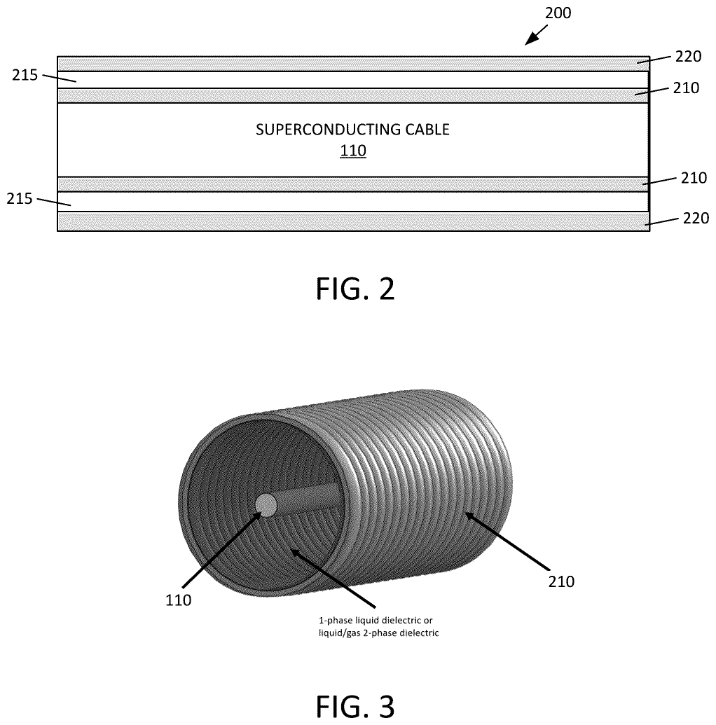

In various embodiments, the superconducting cable 110 is a cable for transmitting current in conditions of superconductivity or conditions of almost null electric resistance. In various embodiments, as shown in FIG. 2, the superconducting cable 110 in included in a container 200, known as a cryostat, comprising two coaxial tubes 210, 220 that provides two concentric phases (conductor and return) in superconducting material, electrically isolated one from the other by a dielectric liquid kept at very low temperature. Accordingly, one or more layers of superconducting material forms the phase conductor that is placed within the inner tube 210 defining an inner cryogenic fluid flowing channel. Thus, in the inner tube 210 where the superconducting cable 110 is, the dielectric liquid or cryogenic fluid flows under high pressure, while a gap 215 is maintained under vacuum between the inner tube 210 and the outer tube 220 of the coaxial tube arrangement. In various embodiments, a thermal insulator is provided within the gap 215 area around the inner tube 210 comprising, in various embodiments, spacer insulating material, radiation shield, etc. In various embodiments, around the thermal insulator layer are wrapped one or more hoses (e.g., spiral hose, flexible hose, vacuum jacketed hose, etc.) of superconducting carrying dielectric liquid or other type of cryogenic fluid as the return conductor.

Generally, the cryogenic fluid is helium, nitrogen, hydrogen, argo, or mixture thereof, at the liquid or gaseous state, and operates at temperature and pressure specific for the application. Typically, said cryogenic fluid is used for ensuring the right operative temperature. Superconducting material may comprise ceramic materials based on mixed oxide of copper, barium and yttrium (YBCO), or of bismuth, lead, strontium, calcium and copper (BSCCO), among others.

In various embodiments, the cryostat structed is comprised of a corrugated tubular conduit, as shown in FIG. 3, with the superconducting cable being a liquid cooled electrical cable. The electrical cable (superconducting, resistive, or cryoresistive) is positioned or travels down a corrugated metal tubular conduit (e.g., inner tube 210 of cryostat 200) and is cooled by a dielectric liquid near boiling point conditions, whether as a 1-phase liquid dielectric or a liquid/gas 2-phase dielectric. The dielectric liquid may be, but is not limited to, a cryogenic fluid. The metallic inner wall of an exemplary inner corrugated cable conduit 210 acts as a radiofrequency waveguide. Thus, in accordance with various embodiments, the RF signal detector 120 can transmit RF pulses (e.g., short RF pulses) to the inner tube 210 (containing dielectric liquid) and/or the superconducting electrical cable 110 itself (within the inner tube 210) and measure an impedance parameter as an operational baseline that can be used to compare against subsequent RF impedance measurements indicating a relative permittivity of the superconducting structure of a dielectric liquid system. In this system, local hot spot formation on the electrical cable 110 will create vaporization conditions and rapidly change the relative permittivity of the superconducting structure. This change in relative permittivity of the now dielectric gas-liquid system can rapidly be detected via the RF signal detector 120 (e.g., a vector network analyzer or real time oscilloscope) by using the corrugated metal conduit 210 and electrical cable 110 as the device under test.

The disclosed technique can utilize the periodic nature of a corrugated tubular cable conduit 210 with an embedded electrical cable 110 surrounded by a dielectric liquid. Hot spot formation anywhere along the length will alter the characteristic impedance of the baseline cable-conduit system due to changes in the relative permittivity of the surrounding dielectric fluid. In the case of a dielectric fluid near the vaporization point, any hot spot formation will dramatically change the relative permittivity and rapidly change the characteristic impedance of the cable-conduit system. With the use of short radiofrequency pulses, all of this creates a rapid hot spot detection system, which does not involve additional instrumentation blocking the fluid pathway or reducing cable cooling. In various embodiments, the system can measure bubbles along very long lengths of cable, dependent on the sensitivity of the equipment and surface resistance losses (Q-factor) of the resonator cavity.

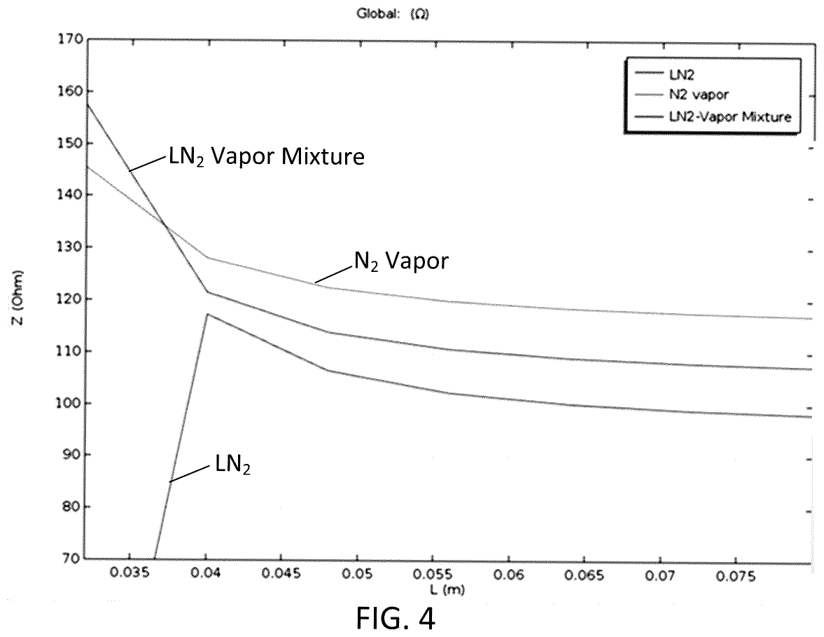

FIG. 4 is a diagram charting RF-signal quench detection using RF interrogation of coolant (LN₂) permittivity. Here, changes in impedance of liquid nitrogen (LN₂) as it changes between a liquid state and a gas/vapor state are shown (using COMSOL Multiphysics simulation tool) across the length of the superconducting structure (having the following geometry: inner diameter: 70 mm, amplitude: 2.5 mm, single sinusoidal corrugation period: 8 mm, cable diameter: 10 mm). The COMSOL Multiphysics is shown for LN₂, N₂ gas, and a mix of N₂ and LN₂. In accordance with the present disclosure, the changes in the dielectric vapor quality will alter transmission coefficient of the waveguide structure of the inner tube 210 or characteristic impedance of the structure depending on the configuration. Temperature increases will change the dielectric constant of the dielectric fluid as a gas-liquid mixture is developed, changing the capacitance/length and transmission coefficient.

Referring back to FIG. 1, in some embodiments, the system 100 includes computing system 140 communicatively coupled to RF signal detector 120 via a network 130. The computing system 140 may be any suitable electronic device configured to receive information from the RF signal detector 120 and/or to process information received from the RF signal detector 120. In some embodiments, the computing system 140 may be a fixed electronic device such as a desktop computer, a rack-mounted computer, or any other suitable fixed electronic device. Alternatively, the computing system 140 may be a portable device such as a laptop computer, a smart phone, a tablet computer, or any other portable device that may be configured to receive information from RF signal detector 120 and/or to process information received from the RF signal detector 120.

The network 130 may be or include one or more local- and/or wide-area, wired and/or wireless networks, including a local-area or wide-area enterprise network and/or the Internet. Accordingly, the network 130 may be, for example, a hard-wired network (e.g., a local area network within a facility), a wireless network (e.g., connected over Wi-Fi and/or cellular networks), a cloud-based computing network, or any combination thereof. It should be appreciated that in some embodiments, however, the computing system 140 may be connected directly to the RF signal detector 120 rather than being connected by the network 130, as aspects of the technology described herein are not limited in this respect.

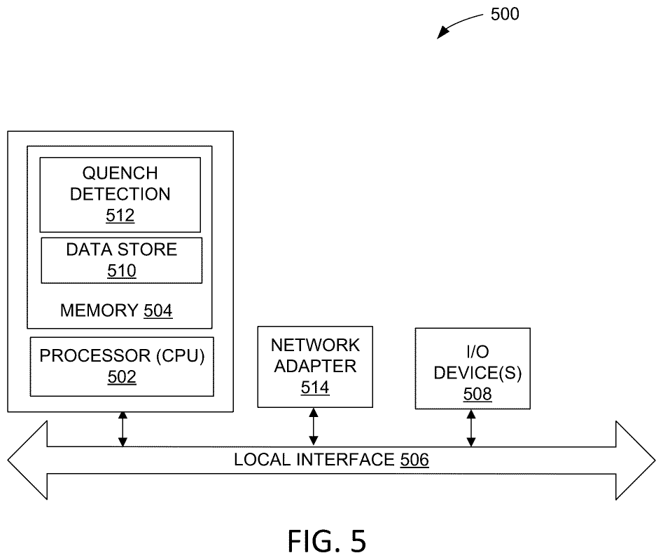

In some embodiments, the computing system 140 may include an RF-signal quench detection application 512 (FIG. 5). The RF-signal quench detection application 512 (FIG. 5) may be configured to analyze data obtained by and/or processed by the RF signal detector 120. The RF-signal quench detection application 512 (FIG. 5) may be configured to, for example, analyze the impedance parameters output by RF signal detector 120 to determine whether a quench event is about to occur and/or is presently occurring in the superconductor cable 110 using the disclosed techniques. For example, the RF-signal quench detection application 512 (FIG. 5) may be configured to determine whether the impedance parameter output by the RF signal detector 120 is greater than a baseline impedance parameter value or a set threshold amount to determine whether a thermal runaway event is about to occur and/or is presently occurring. The RF-signal quench detection application 512 (FIG. 5) may be implemented as hardware, software, or any suitable combination of hardware and software, as aspects of the technology described herein are not limited in this respect.

FIG. 5 illustrates one exemplary implementation of a computing system 140 in the form of a computing device 500 that may be used in a system implementing techniques described herein, although others are possible. It should be appreciated that FIG. 5 is intended neither to be a depiction of necessary components for a computing device to operate as an RF-signal quench detection system in accordance with the principles described herein, nor a comprehensive depiction.

An exemplary computing device 500 includes at least one processor circuit, for example, having a processor (CPU) 502 and a memory 504, both of which are coupled to a local interface 506, and one or more input and output (I/O) devices 508. The local interface 506 may comprise, for example, a data bus with an accompanying address/control bus or other bus structure as can be appreciated. The computing device 500 may further include Graphical Processing Unit(s) (GPU) that are coupled to the local interface 506 and may utilize memory 504 and/or may have its own dedicated memory. The CPU and/or GPU(s) can perform any of the various operations described herein.

Stored in the memory 504 are both data and several components that are executable by the processor 502. In particular, stored in the memory 504 and executable by the processor 502 are code (512) for implementing the quench detection application 512. Also stored in the memory 504 may be a data store 510 and other data. The data store 510 may store data related to the computations performed by the quench detection processes. In addition, an operating system may be stored in the memory 504 and executable by the processor 502. The I/O devices 508 may include input devices, for example but not limited to, a keyboard, mouse, RF signal detector 120, etc. Furthermore, the I/O devices 508 may also include output devices, for example but not limited to, a printer, display, etc.

Computing device 500 may be, for example, a desktop or laptop personal computer, a personal digital assistant (PDA), a smart mobile phone, or any other suitable computing device. Network adapter 514 may be any suitable hardware and/or software to enable the computing device 500 to communicate wired and/or wirelessly with any other suitable computing device over any suitable communication/computing network 130. The network 130 may include wireless access points, switches, routers, gateways, and/or other networking equipment as well as any suitable wired and/or wireless communication medium or media for exchanging data between two or more computers, including the Internet.

Embodiments of the present disclosure can be implemented in hardware, software, firmware, or a combination thereof. In an exemplary embodiment, exemplary quench detection logic or functionality is implemented in software or firmware that is stored in a memory and that is executed by a suitable instruction execution system. If implemented in hardware, as in an alternative embodiment, quench detection logic or functionality can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Embodiments of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In summary, systems and methods of the present disclosure are configured to perform quench or hot spot detection on a long electrical cable in a conduit and readily identify quench conditions which provides a valuable and needed service in modern and future applications. For example, as cryoresistive and superconducting cables are currently being designed as an enabling technology for future large passenger electric aircraft, safety will be paramount in these new aerospace vehicles. In addition, multi-kilometer long superconducting transmission cables are being installed at an increasing number of locations. The integration of superconducting transmission cables to the grid and to superconducting and cryoresistive cables into large passenger electric aircraft is coming quickly, and this technology would assist the safety of such systems greatly.

It should be emphasized that the above-described embodiments are merely possible examples of implementations, merely set forth for a clear understanding of the principles of the present disclosure. Many variations and modifications may be made to the above-described embodiment(s) without departing substantially from the principles of the present disclosure. All such modifications and variations are intended to be included herein within the scope of this disclosure.

Therefore, having thus described the invention, at least the following is claimed:

1. A system comprising:
a cable extending down a metal tubular conduit and being cooled by a dielectric liquid near boiling point conditions to form a cable-conduit system; and
a vector network analyzer that is configured to inject a stimulus signal and detect a local hot spot formation on the cable via a change in relative permittivity of the cable-conduit system.

2. The system of claim 1, wherein the metal tubular conduit comprises a corrugated metal tubular conduit.

3. The system of claim 1, wherein the local hot spot formation is detected by measuring changes in radio frequency (RF) impedance in the dielectric liquid.

4. The system of claim 1, wherein the cable is superconducting, resistive, or cryoresistive.

5. The system of claim 1, wherein the metal tubular conduit is an inner metallic layer of a cable cryostat.

6. The system of claim 1, wherein the dielectric liquid is a cryogenic fluid.

7. The system of claim 1, wherein the stimulus signal comprises radiofrequency pulses.

8. The system of claim 1, wherein the cable-conduit system is integrated in an electric aircraft.

9. The system of claim 1, wherein the cable-conduit system is integrated in an electric grid.

10. The system of claim 1, wherein the cable comprises ceramic materials based on mixed oxide of copper, barium and yttrium (YBCO), or of bismuth, lead, strontium, calcium and copper (BSCCO).

11. The system of claim 1, wherein the dielectric liquid comprises helium, nitrogen, hydrogen, argo, or mixture thereof.

12. A method comprising:
extending a cable within an interior length of a metal tubular conduit;
cooling the extended cable with a dielectric liquid near boiling point conditions to form a cable-conduit system; and
injecting a stimulus signal and detecting, via a vector network analyzer, a local hot spot formation on the cable via a change in relative permittivity of the cable-conduit system.

13. The method of claim 12, wherein the metal tubular conduit comprises a corrugated metal tubular conduit.

14. The method of claim 12, wherein the local hot spot formation is detected by measuring changes in radio frequency (RF) impedance in the dielectric liquid.

15. The method of claim 12, wherein the cable is superconducting, resistive, or cryoresistive.

16. The method of claim 12, wherein the metal tubular conduit is an inner metallic layer of a cable cryostat.

17. The method of claim 12, wherein the stimulus signal comprises radiofrequency pulses.

18. The method of claim 12, wherein the cable comprises ceramic materials based on mixed oxide of copper, barium and yttrium (YBCO), or of bismuth, lead, strontium, calcium and copper (BSCCO).

19. The method of claim 12, wherein the dielectric liquid comprises helium, nitrogen, hydrogen, argo, or mixture thereof.

20. The method of claim 12, further comprising:
measure an impedance parameter of the cable as an operational baseline; and
comparing the operational baseline against subsequent RF impedance measurements of the cable to indicate a relative permittivity of the cable.
